(19) United States
(12) Patent Application Publication
(10) Pub. No.: US 2025/0325870 A1
(43) Pub. Date: Oct. 23, 2025

(54) HANDS-FREE PROGRESSIVE STRETCHING DEVICE

(71) Applicants: Zvi Dhari, Valley Village, CA (US); Galia Dhari, Valley Village, CA (US); Maor Dhari, Valley Village, CA (US)

(72) Inventors: Zvi Dhari, Valley Village, CA (US); Galia Dhari, Valley Village, CA (US); Maor Dhari, Valley Village, CA (US)

(21) Appl. No.: 19/185,028

(22) Filed: Apr. 21, 2025

Related U.S. Application Data
(60) Provisional application No. 63/637,259, filed on Apr. 22, 2024.

(51) Int. Cl. A63B 23/04; A63B 21/00; A63B 21/068; A63B 21/08; A63B 23/00

(52) U.S. Cl. CPC A63B 23/0494; A63B 21/00; A63B 21/068; A63B 21/08; A63B 21/4013; A63B 21/4015; A63B 2023/006; A63B 2220/52

(57) ABSTRACT

An exercise device is disclosed to enable a user to stretch the lower limbs, lower back, hamstrings, gluteal tendons and gluteal fasciae for pain relief. The stretching device includes a padded body rest having back and leg rest sections hingedly connected together and rotatable from an unfolded configuration to a compact folded configuration lying face-to-face. First and second pairs of leg lifting straps are connected to one another by respective cam jam buckles so as to extend between the body rest and cuffs that surround the user's ankles and feet. A pulling force applied to each leg lifting strap causes the user's legs to be raised off the body rest from a horizontal flat position to a vertical upstanding position. Force monitors are located between the pairs of the leg lifting straps and the user's legs to provide a visual indication of the pulling force.

### CROSS-REFERENCE TO RELATED APPLICATIONS

This application claims the benefit of Provisional Patent Application No. 63/637,259 filed Apr. 22, 2024.

### BACKGROUND OF THE INVENTION

### 1. Field of the Invention

This invention relates to a portable stretching device that enables variable and controllable forces to be generated for stretching a user's legs, feet, ankles, knees, and lower back without the user's hands and other muscles being involved. The device includes force monitors that provide the user with a visual feedback of the lifting force generated so that the force can be adjusted to meet the capabilities and needs of the user during a stretching exercise.

### 2. Background Art

Due to the nature of one's rigorous employment over time, athletic experiences or the aging process, individuals become susceptible to pain in their lower limbs, lower back, hamstrings, gluteal tendons, and gluteal fascia. It is known in the sporting field that hamstring stretching by one in a supine posture improves athletic performance, decreases incidence of hamstring injury, promotes circulation, and is helpful in alleviating lower back pain. In this regard, having the ability to isolate the stretching force specific to the right and left legs will allow an individual to gradually and painlessly apply less or more force to each leg until the individual is able to provide equal force bilaterally. For example, injury to an individual's plantar fascia, ankle, calf, knee, hamstring, sarco-iliac, or lumbar spine may prevent the individual from effectively releasing the fascia, leg muscle or joint that is specific to one extremity over the other.

Leg stretching devices have been used to stretch muscles of the legs and lower back of an individual lying in a supine position. However, such conventional devices are typically expensive, bulky, hard to transport and/or store, and often involve complex instructions or the assistance of another individual. What is more, no conventional stretching devices is known which provides a visual readout or feedback to the user of the stretching force being applied when a bilateral hamstring stretch is performed. Likewise, no stretching device is known that enables a user to generate an adjustable stretching tension to permit the user to finely adjust, by visual feedback, the tension level comparison between the left and right legs.

Therefore, what is desirable is a hands-free, lightweight, inexpensive and easy to use and transport progressive stretching device which allows a user to incrementally adjust the stretch force between the left and right legs in order to promote improved comfort and targeting of a passive stretch to accommodate an individual's specific therapeutic needs and abilities. In particular, a stretching device is desirable that will enable users to treat their lower limbs, lower back, hamstrings, gluteal tendons, and gluteal fascia for pain relief. The stretching device should ideally be capable of providing users with precise visual feedback so that a stretching force can be specifically tailored to the right and left foot, ankle, knee, and lower back which allows users to rehabilitate joint, fascia, and muscle injuries in an incremental and comfortable manner.

### SUMMARY OF THE INVENTION

In general terms, a portable progressive stretching device is disclosed that enables controllable forces to be selectively applied to the left and right legs of a user to enable the user's legs, feet, ankles, knees and lower back to be stretched without use of the user's hands and other muscles in order to relieve pain and address specific therapeutic needs of the user. The stretching device includes a flat padded board having a backrest at one end on which the head and back of the user are laid and a leg rest at the opposite end on which the user's legs are laid. The backrest and leg rest are pivotally connected end-to-end one another and adapted to be rotated around a hinge pin so as to lie one against the other when they are not in use to create a compact package that is suitable for transport and storage.

First and second pairs of leg lifting straps extend from the backrest of the stretching device, over the shoulders of the user who lays flat on the padded board, to respective ones of a pair of force monitors. The force monitors are responsive to stretching (i.e., pulling) forces that are applied by the user to respective ones of the user's legs by way of the leg lifting straps. The force monitors provide the user with a visual feedback to enable the stretching forces to be incrementally adjusted and tailored to fit the specific needs and capabilities of the user. In this regard, each force monitor has a transparent window at its front through which force readings are visible to the user.

Each force monitor also has a hook projecting therefrom that is coupled to one of a set of D-rings from an ankle cuff that surrounds an ankle of the user and one of a set of D-rings from a foot cuff that surrounds one of the user's feet. Therefore, a pulling force applied to the pairs of leg lifting straps causes the legs of the user to be raised from a horizontal position lying flat on the leg rest of the padded board to a vertical position standing upwardly from the leg rest at which the user's legs, lower back, ankles and knees can be exercised. The legs of the user are held in place upright until the stretching exercise is completed, whereupon the user's legs are lowered to their initial horizontal position on the leg rest.

### BRIEF DESCRIPTION OF THE DRAWINGS

FIG. 1 shows an exploded view of a progressive stretching device for stretching the human body according to a preferred embodiment of this invention;

FIG. 2 is a top view of a padded board of the stretching device shown in FIG. 1 on which a user lays while stretching;

FIG. 3 is a bottom view of the padded board of the stretching device shown in FIG. 1;

FIGS. 4-6 show a force monitor having a transparent window and being adapted to provide the user with a visual feedback of the stretching force that is generated to lift one of the user's legs off the padded board of the stretching device of FIG. 1;

FIGS. 7 and 8 show pairs of leg lifting straps attached from the front of the padded board to the user's ankles and feet by way of respective force monitors so that stretching forces applied to the straps causes the legs of the user to be lifted upright on the padded board;

FIGS. 9-11 show a first modification to the stretching device for attaching the leg lifting straps of FIGS. 7 and 8 directly to an ankle and foot of one leg of the user without the use of a force monitor;

FIG. 12 shows the stretching device of FIGS. 7 and 8 with the addition of a pair of muscle strengthening straps and a force monitor extending laterally between the feet of the user; and

FIGS. 13-15 show a second modification to the stretching device for attaching one of the leg lifting straps of FIGS. 7 and 8 directly to a foot of the user.

### DESCRIPTION OF THE PREFERRED EMBODIMENT

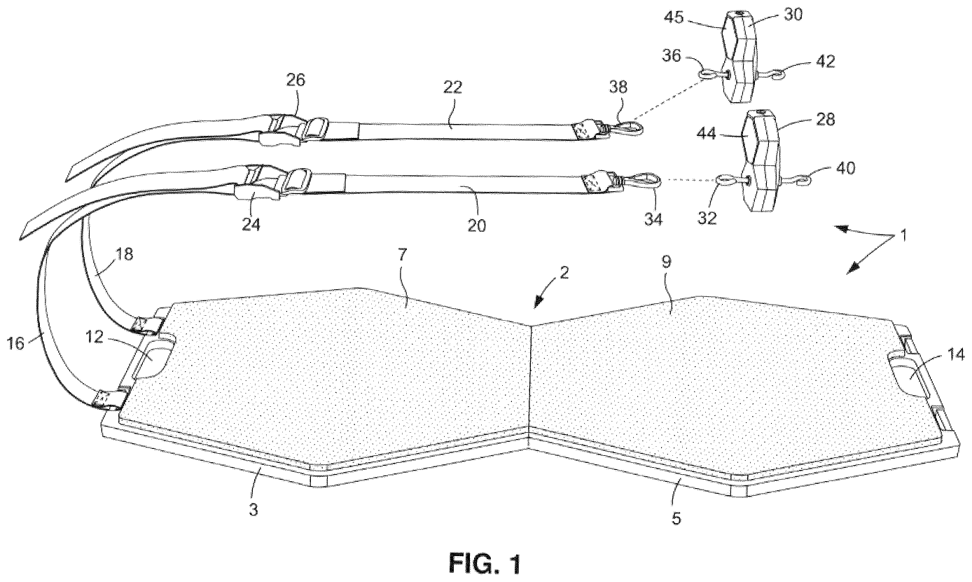

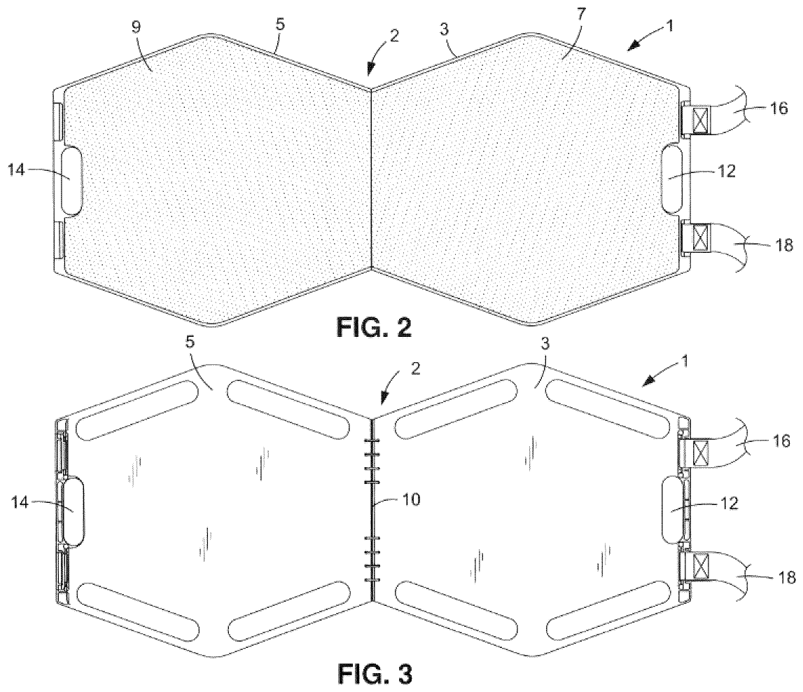

The portable progressive stretching device 1 for stretching the human body which forms the present invention is initially described while referring to FIGS. 1-3 of the drawings. As will be explained in greater detail hereinafter, our stretching device 1 allows a convenient hands-free means for users to stretch their lower limbs, lower back, hamstrings, gluteal tendons and gluteal fascia for exercise and pain relief. Users are provided with a precise visual feedback of the force required to lift their legs in order to enable balanced tailored stretching forces to be selectively applied for exercising a user's right and left side feet, ankles, knees and lower back in comfort as is necessary to help the user's body heal from the effects of inactivity, age or injury. The stretching device 1, which is sized to accommodate a human body, can be folded up to facilitate the convenient transport and storage thereof.

The portable stretching device 1 is shown including a padded board 2 having a pair of polygon-shaped forward and rear back and leg rests 3 and 5 that are pivotally connected end-to-end to be laid open upon a flat surface. The back and leg rests 3 and 5 are preferably manufactured from wood or plastic and sized to enable a user to lay flat with the user's head, back and legs supported thereon. However, it is to be understood that the particular number, shape and material of the back and leg rests 3 and 5 of the padded board 2 of the stretching device 1 are matters of choice and should not be considered as limitations of our invention.

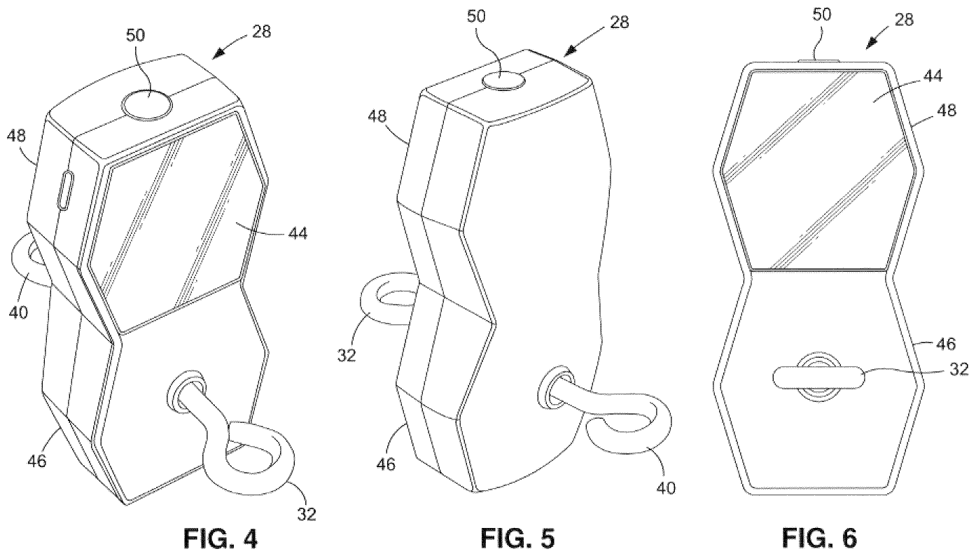

A cushion (e.g., TPE foam) pad 7 and 9 is affixed to the top of each of the forward and rear back and leg rests 3 and 5 to absorb the weight of the user and enable a stretching exercise to be undertaken in comfort. During a use of the stretching device 1, the back and leg rests 3 and 5 and the cushion pads 7 and 9 attached thereover are laid on a floor or similar flat surface. The padded board 2 is held down entirely by the weight of the user. The back and leg rests 3 and 5 are pivotally connected together by a (e.g., stainless steel) hinge pin (designated 10 and best shown in FIG. 3). In this manner, when the stretching device 1 is not being used, the back and leg rests 3 and 5 can be folded around the hinge pin 10 to rotate towards and against one another to create a compact configuration (not shown) that is ideal for transport in a motor vehicle or storage in a closet at home. An opening 12 and 14 is formed in the outer-most end of each of the back and leg rests 3 and 5 so that when the rests are folded up one against the other, a handle is established to enable the stretching device to be more easily carried.

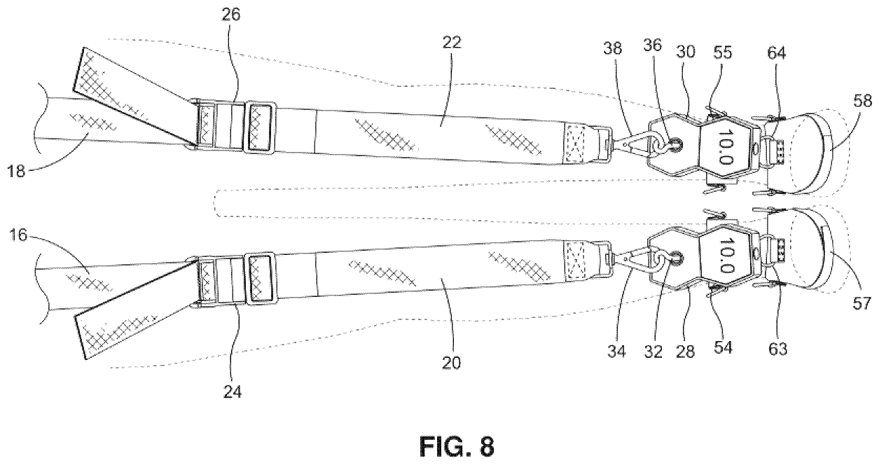

A first pair of leg lifting straps 16 and 18 are connected at first ends thereof to the outer-most end of the forward back rest 3 on which the head and back of the user are laid (best shown in FIG. 7). The opposite ends of the first pair of leg-lifting straps 16 and 18 are attached to the first ends of respective ones of a second pair of leg-lifting straps 20 and 22. The first and second pairs of leg-lifting straps 16, 18 and 20, 22 are coupled one to another by conventional cam jam buckles 24 and 26. The can jam buckles 24 and 26 allow the overall length of the first and second pairs of leg lifting straps 16, 18 and 20, 22 to be either fixed or selectively adjusted depending upon the size of the user and the location of the user's legs on the rear leg rest 5. However, it is to be understood that the buckles 24 and 26 can be eliminated entirely such that the first and second pairs of leg lifting straps 16, 18 and 20, 22 are replaced by one-piece continuous leg lifting straps (not shown).

The opposite end of each strap 20 and 22 of the second pair of leg lifting straps is coupled to a respective force monitor 28 and 30. That is, a first hook 32 that projects from the front of a first of the force monitors 28 is detachably connected to an opposing first swivel clip 34 that is attached to the opposite end of the first strap 20 of the second pair of leg-lifting straps. A first hook 36 that projects from the front of the second force monitor 30 is detachably connected to an opposing second swivel clip 38 that is attached to the opposite end of the second strap 22 of the second pair of leg lifting straps. Each force monitor 28 and 30 that is attached to one of the pairs of end-to-end connected leg lifting straps 16, 20 and 18, 22 also has a second hook 40 and 42 projecting from the rear to be attached to one ankle and one foot of the user of the progressive stretching device (also best shown in FIG. 7).

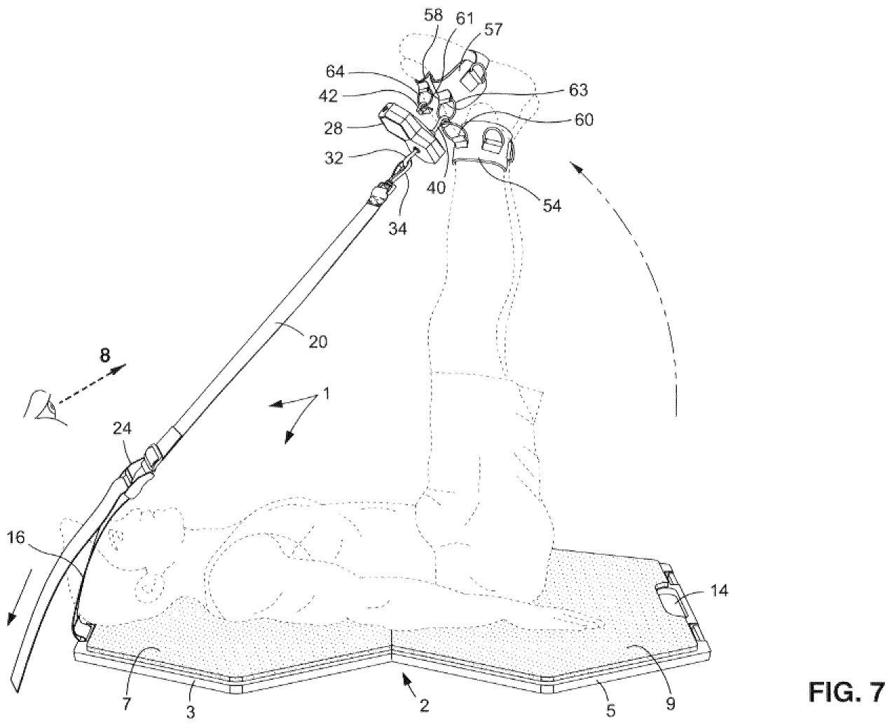

Turning now to FIGS. 4-6 of the drawings, one of the just described force monitors, (e.g., 28) is shown having first and second hooks 32 and 40 projecting from the front and rear thereof so that the force monitor 28 can be held between one strap 20 of the pair of end-to-end connected leg lifting straps 16 and 20 and one leg of the user at which to be responsive to the force that is applied to the leg lifting strap 20 when the user's leg is raised above the rear leg rest 5 on which the leg lays when at rest. The force monitor 28 has a transparent window 44 at the front which faces the head of the user to enable the user to receive visual force feedback readings that are generated during the user's stretching exercise. In this regard, and by way of example only, the force monitor 28 is a conventional digital luggage scale or the like that is adapted to display an indication of the force to which the monitor is responsive. The other force monitor 30 of FIG. 1 also has a transparent window 45 through which visual force feedback readings are displayed to the user.

The force monitor 28 has a housing with lower and upper modules 46 and 48 stacked one above the other. The first and second hooks 32 and 40 are anchored inside the lower module 46 to project outwardly through the front and rear thereof. Force sensing electronics are packaged within the upper module 48 of monitor 28 to measure the lifting force that it receives by way of the pair of end-to-end connected leg lifting straps 16 and 20 of FIG. 1 when the user's leg is raised off the rear leg rest 5 of the padded board 2. The force sensing electronics of the first monitor 28 includes a digital readout that displays the lifting force which is made visible to the user through the transparent window 44 located on the upper module 48 of the monitor. An on-off push button switch 50 at the top of the upper module 48 controls the delivery of (e.g., battery) power to the force sensing electronics.

FIGS. 7 and 8 of the drawings show means by which the second pair of leg lifting straps 20 and 22 of the stretching device 1 of FIG. 1 are removable attached to the left and right ankles and feet of a user. By virtue of the foregoing, variable and controllable lifting forces are produced so that the legs of the user can be raised and lowered between a horizontal position laying flat on the rear leg rest 5 and a vertical upstanding position. To this end, an ankle cuff 54 and 55 is wrapped around each ankle of the user and a foot cuff 57 and 58 is wrapped around each of the user's feet. Opposite ends of each ankle cuff 54 and 55 are held together by hook and loop Velcro fastener material, and opposite ends of each foot cuff 57 and 58 are held together by a flexible band 59. A first set of D-rings 60 and 61 are evenly spaced around each ankle cuff 54 and 55 which surrounds each of the user's ankles. A second set of D-rings 63 and 64 are located on top of each foot cuff 57 and 58 which surrounds the user's feet.

The progressive stretching device 1 is assembled so that the lifting forces generated when the user's legs are raised are transmitted to the force monitors 28 and 30 by way of the first and second pairs of leg lifting straps 16, 18 and 20, 22. In this regard, and continuing to refer to FIGS. 7 and 8, the second pair of leg lifting straps 20 and 22 are shown attached to respective force monitors 28 and 30. That is, the swivel clips 34 and 38 at the ends of straps 20 and 22 are coupled to the first hooks 32 and 36 that project from the front of the monitors 28 and 30. The first monitors 28 and 30 are then attached to the ankle and foot cuffs 54, 55 and 57, 58 that surround the ankles and feet of the user. In this case, the second hooks 40 and 42 which project from the rear of the monitors 28 and 30 are coupled to the D-rings 60, 61 and 63, 64 that are attached to the ankle and foot cuffs. That is, the hook 40 that projects from the force monitor 28 is coupled to one each of the sets of D-rings 60 and 63 from the ankle and foot cuffs 54 and 57. The hook 42 that projects from the force monitor 30 is coupled to one each of the sets of D-rings 61 and 64 from the ankle and foot cuffs 55 and 58. Each of the ankle and foot cuffs 54, 55 and 57, 58 has a set of D-rings located therearound to allow pulling forces to be selectively applied to the user's ankles and feet in any one of a variety of different directions for stretching the user's leg muscles without the user's hands.

It may be appreciated that the first and second pairs of leg lifting straps 16, 18 and 20, 22 of the stretching device 1 extend between the outer-most end of the forward backrest 3, over the user's shoulders at which to be connected to D-rings that are attached to the ankle and foot cuffs 54, 55 and 57, 58 that surround the ankles and feet of the user whose legs will be raised and lowered. FIG. 7 shows the user's head and back laying on the forward backrest 3 to hold the padded board 2 of device 1 against the floor. However, it is to be understood that the user's head can be laid on a pillow (not shown) that lies beyond the forward backrest 3. Accordingly, the pulling (i.e., stretching) forces are applied to the user's legs by way of the first and second pairs of leg lifting straps 16, 18 and 20, 22. The user's legs will then be raised by the lifting straps above the padded board 2 and held in place in the upstanding position by closing the cam jam buckles 24 and 26. When the hands-free stretching exercises are completed, the buckles 24 and 26 are opened, and the user's legs can then be lowered and returned to their initial prone position.

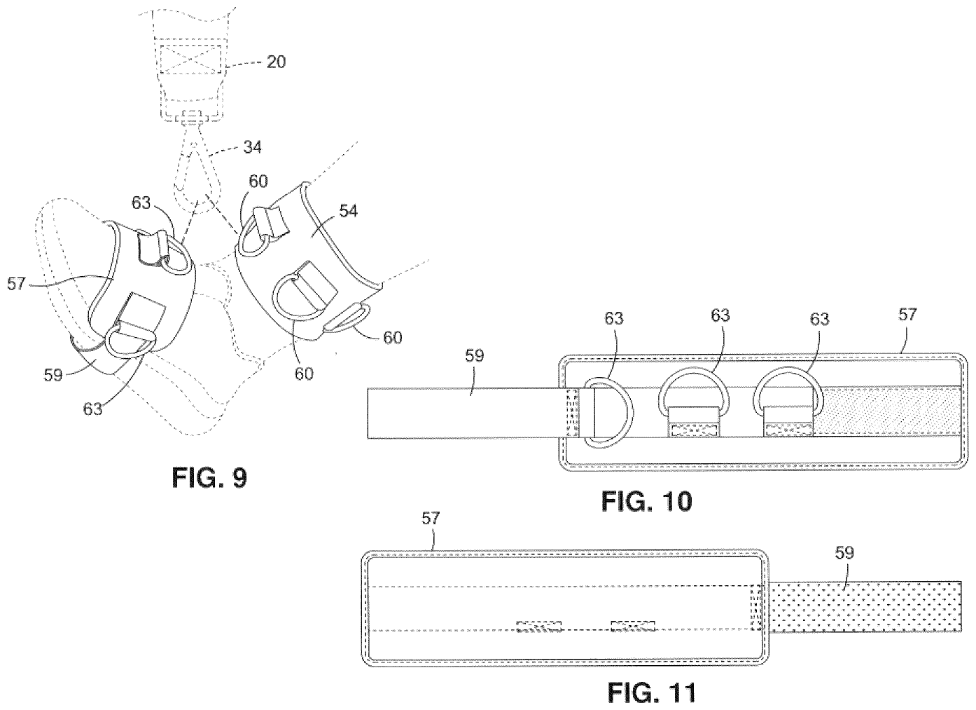

It should also be understood that the force monitors 28 and 30 are optional and may be removed from the stretching device 1 when force readouts are not necessary to be visible to the user. In this case, and as is best shown in FIGS. 9-11 of the drawings, the swivel clips (only one of which 34 being shown) at the ends of the second pair of leg lifting straps (only one of which 20 also being shown) are attached directly to one D-ring 60 and 63 from the sets of D-rings of an ankle cuff 54 that surrounds one of the user's ankles and a foot cuff 57 that surrounds the user's foot.

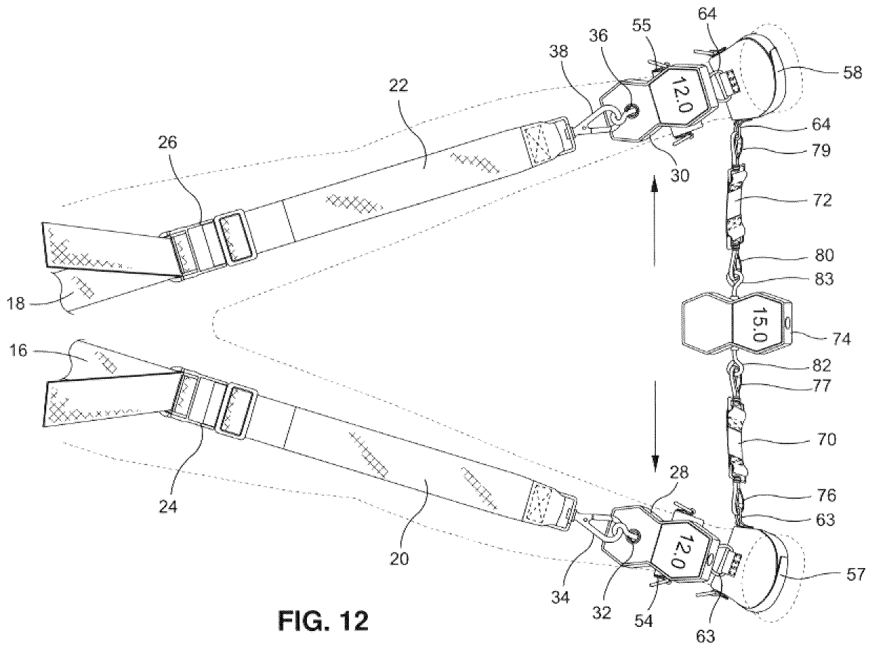

FIG. 12 of the drawings shows a modification to the progressive stretching device 1 of FIG. 7 that allow a specific force to be generated in order to strengthen the user's inner thigh (i.e., abductor) muscles without the user's hands being used. In this case, first and second adjustable muscle strengthening straps 70 and 72 with an optional force monitor 74 (that is identical to the force monitor 28 shown in FIGS. 4-6) detachably connected therebetween extend across the body and between the feet of the user. The first adjustable muscle strengthening strap 70 has a swivel clip 76 and 77 located at each of the opposite ends thereof. The second adjustable muscle strengthening strap 72 also has a swivel clip 79 and 80 located at each of the opposite ends thereof. A first hook 82 projects from one side of the force monitor 74, and a second hook 83 projects from the opposite side.

The optional force monitor 74 is suspended between the user's feet by connecting the hook 82 at one side of the force monitor 74 to the swivel clip 77 at one end of the first muscle strengthening strap 70. The swivel clip 76 at the opposite end of strap 70 is then removably attached to one of the D-rings 63 from the foot cuff 57 that surrounds one foot of the user. The hook 83 at the opposite side of the force monitor 74 is connected to the swivel clip 80 at one side of the second muscle strengthening strap 72. The swivel clip 79 at the opposite end of strap 72 is then removably attached to one of the D-rings 64 from the foot cuff 58 that surrounds the other one of the user's feet. When the user's feet are spread apart, the force monitor 74 provides a visual indication to enable the user to adjust the force during a stretching exercise in order to balance the forces that are directed to the user's hips, pelvis and lower back. However, the optional force monitor 74 can be removed, such that the D-rings 63 and 64 of the foot cuffs 57 and 58 are connected together by either a continuous muscle strengthening strap (not shown) or by the pair of straps (e.g., 70 and 72) being connected end-to-end.

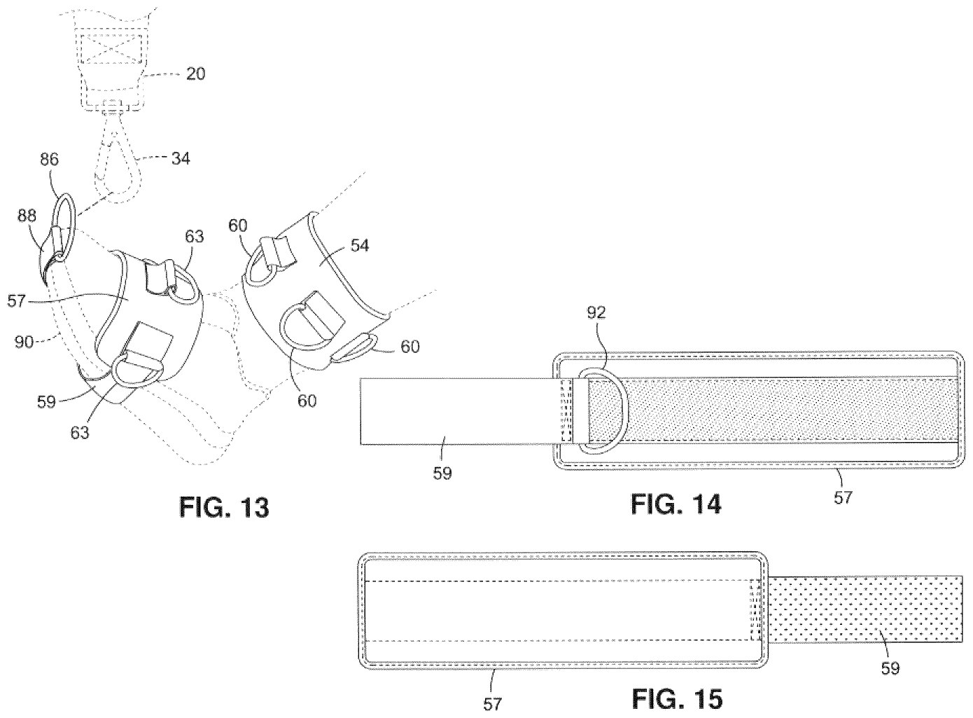

FIGS. 13-15 of the drawings show a modification to each of the foot cuffs (e.g., 57) of FIG. 7 that surround one of the user's feet when a specific stretching forces is to be generated to exercise the user's calf without the user's hands. In this case, an additional D-ring 86 is attached by a narrow band 88 that extends longitudinally along the bottom of one of the user's shoes 90 at which to be attached to the narrow band 59 that extends laterally across the bottom of the shoe 90 to hold the opposite ends of the foot cuff 57 together around the top of the shoe. The bands 59 and 88 are sized so that the additional D-ring 86 will be located against the toe of the user's shoe 90. The swivel clip 34 that is connected to an end of one strap (e.g., 20) of the second pair of leg lifting straps 20 and 22 of FIG. 1 is removably attached directly to the D-ring 86 at the toe of the shoe 90 so that a force can be applied to the user's calf by way of the bands 59 and 88 to which the D-ring is interconnected.

Each ankle cuff (e.g., 54) and foot cuff (e.g., 57) which surrounds the user's ankle and foot has heretofor been described as preferably having a set of D-rings (e.g., 60 and 63) attached therearound so that stretching forces can be applied in different directions. However, it is to be understood that the sets of D-rings can be replaced by a single D-ring (designated 92 in FIG. 14). In this case, a stretching force will be applied to the user's ankle and foot in a single direction depending on the location of the D-ring.

The progressive stretching device 1 herein disclosed isolates the user's back for an ideal hamstring and lower back stretch. The stretching device 1 has particular application to users with knee or hip arthritis by stretching the tendons on the back of the knee and hip to lessen the forces across the knee and hip which can lead to a reduction in pain caused by arthritis. The device 1 also advantageously provides a piriformis stretch adding to increased range of motion of the lower back and all muscles and tendons interconnected therewith. Other benefits may be achieved by using the stretching device 1 of this invention to achieve improved blood circulation, decreased swelling in the legs and feet, enhanced relaxation, tension relief on the neck, and reduced stress on the arms, legs and shoulders.

1. An exercise device for stretching the human body, comprising:
a body rest configured to support the back and legs of a user;
at least first and second leg lifting straps having first ends thereof communicating with said body rest and opposite ends attached to respective first couplers; and
first and second cuffs configured to surround respective ones of the ankles of the user, each of said first and second cuffs having a second coupler,
the first couplers from said first and second leg lifting straps being detachably connected to respective ones of the second couplers from said first and second cuffs such that a pulling force applied to each of said first and second leg lifting straps is transferred to the legs of the user by way of said first and second cuffs to cause the legs of the user to be raised from a horizontal position lying flat on the body rest to a vertical position standing upwardly from the body rest.

2. The exercise device recited in claim 1, wherein there are a plurality of said second couplers spaced from one another around each of said first and second cuffs such that the pulling force applied to each of said first and second leg lifting straps is applied to the legs of the user at one of the second couplers from each of the pluralities of second couplers.

3. The exercise device recited in claim 1, further comprising third and fourth cuffs configured to surround respective ones of the feet of the user, each of said third and fourth cuffs having a third coupler, the first couplers from said first and second leg lifting straps also being detachably connected to respective ones of the third couplers from said third and fourth cuffs such that the pulling force applied to each of said first and second leg lifting straps is also transferred to the legs of the user by way of said third and fourth cuffs to further cause the legs of the user to be raised from the horizontal position to the vertical position.

4. The exercise device recited in claim 3, wherein there are a plurality of said third couplers spaced from one another around each of said third and fourth cuffs such that the pulling force applied to each of said first and second leg lifting straps is applied to the legs of the user at one of the third couplers from each of said pluralities of third couplers.

5. The exercise device recited and claim 3, further comprising at least one muscle strengthening strap extending laterally between said third and said fourth cuffs which surround the feet of the user by which to enable the calves of the user to be exercised.

6. The exercise device recited in claim 3, further comprising a first muscle strengthening strap connected at one end thereof to the third cuff which surrounds one foot of the user, a second muscle strengthening strap connected at one end thereof to the fourth cuff which surrounds the second foot of the user, and a force monitor connected between opposite ends of said first and second muscle strengthening straps at which to be responsive to a lateral calf strengthening force applied to the legs of the user at said third and fourth cuffs.

7. The exercise device recited in claim 3, further comprising a fourth coupler interconnected with respective ones of said third and fourth cuffs that surround the feet of the user, said fourth couplers being sized to lie below the feet of the user, the first couplers from said first and second leg lifting straps to be detachably connected to respective ones of said fourth couplers such that the pulling force applied to each of said first and second leg lifting straps is transferred to said forth couplers to stretch the feet of the user.

8. The exercise device recited in claim 1, further comprising first and second force monitors respectively connected between the first couplers from said first and second leg lifting straps and the second couplers from said first and second cuffs, said first and second force monitors being responsive to the pulling force applied to each of said first and second leg lifting straps to provide an indication thereof.

9. The exercise device recited in claim 8, wherein each of said first and second force monitors has a transparent window through which the indication of the pulling force to which said force monitors are responsive is visible to the user.

10. The exercise device recited in claim 1, further comprising third and fourth leg lifting straps connected at first ends thereof to said body rest and at opposite ends to respective first and second buckles, said first and second leg lifting straps being coupled respectively to said third and fourth leg lifting straps by way of said first and second buckles so as to extend between said body rest and the legs of the user.

11. The exercise device recited in claim 10, wherein each of said first and second buckles by which said first and second leg lifting straps are coupled to said third and fourth leg lifting straps is a cam jam buckle that is operable to adjust the length of said first and second leg lifting straps and said third and fourth leg lifting straps extending between said body rest and the legs of the user.

12. The exercise device recited in claim 11, wherein said first and second cam jam buckles have a locked condition at which said first and second leg lifting straps coupled to said third and fourth leg lifting straps hold the legs of the user in the vertical position standing upwardly from said body rest, said cam jam buckles also having an unlocked condition at which the legs of the user are lowered to the horizontal position on said body rest.

13. The exercise device recited in claim 1, wherein said body rest includes a first end sized to receive the back of the user and an opposite end sized to receive the legs of the user, the first and opposite ends of said body rest being pivotally connected together and rotatable relative to one another from an unfolded configuration lying end-to-end to a folded configuration one facing the other.

14. The exercise device recited in claim 13, wherein each of the first and opposite ends of said body rest is a flat board covered by a cushion pad.
